(19) United States
(12) Patent Application Publication
(10) Pub. No.: US 2024/0253126 A1
(43) Pub. Date: Aug. 1, 2024

(54) Rules Based Scan Strategy for Powder Bed Fusion

(71) Applicant: Board of Regents, The University of Texas System, Austin, TX (US)

(72) Inventors: Hunter Taylor, El Paso, TX (US); Ryan B. Wicker, El Paso, TX (US)

(21) Appl. No.: 18/425,892

(22) Filed: Jan. 29, 2024

Related U.S. Application Data
(60) Provisional application No. 63/482,372, filed on Jan. 31, 2023.

(51) Int. Cl. B22F 10/85; B22F 10/28; B33Y 10/00; B33Y 50/02

(52) U.S. Cl. CPC B22F 10/85; B22F 10/28; B33Y 10/00; B33Y 50/02

(57) ABSTRACT

Laser powder bed fusion additive manufacturing of parts is provided. The method comprises converting a 3D geometry for a part into a number of 2D layers, wherein the 2D layers contain information about the local 3D geometry. A number of laser scan parameters are specified according to preexisting empirical melt pool data for a specified build material. Laser energy levels are specified according to unique characteristics of a specific powder bed fusion machine. Laser and laser beam steering are controlled in the specific powder bed fusion machine according to the specified laser scan parameters and specified laser energy levels to additively manufacture the part from the specified build material.

### CROSS-REFERENCE TO RELATED APPLICATION

This application claims the benefit of U.S. Provisional Application Ser. No. 63/482,372, filed Jan. 31, 2023, entitled “Rule Based Scan Strategy for Powder Bed Fusion”, which is incorporated herein by reference in its entirety.

### BACKGROUND INFORMATION

### 1. Field

The present disclosure relates generally to additive manufacturing, and more specifically to a process for laser powder bed fusion and certifying digital instructions for laser powder bed fusion.

### 2. Background

The laser powder bed fusion (LPBF) process is strongly influenced by the scanning strategy that determines the laser beam path along with its speed and power. However, each LPBF Original Equipment Manufacturer (OEM) handles, among other things, scanning strategies differently making equivalency across platforms difficult to impossible, and thus, preventing a common material data sheet to exist. It has been shown that parameters beyond what most machine manufacturers allow for user access can affect the process quality, including such parameters as the effect of skywriting angle, laser delays, and more advanced functions like laser power ramping.

### SUMMARY

An illustrative embodiment provides a computer-implemented method of laser powder bed fusion additive manufacturing of parts. The method comprises converting a 3D geometry for a part into a number of 2D layers, wherein the 2D layers contain information about the 3D geometry. A number of laser scan parameters are specified according to preexisting empirical melt pool data for a specified build material. Laser energy levels are specified according to laser incident angle. Laser and laser beam steering are controlled in the specific powder bed fusion machine according to the specified laser scan parameters and specified laser energy levels to additively manufacture the part from the specified build material.

Another illustrative embodiment provides a computer-implemented method of laser powder bed fusion additive manufacturing of parts. The method comprises converting a 3D geometry into 2D layers, wherein the 2D layers contain information about the 3D geometry, and wherein the 2D layers define at least one target melt pool characteristic for regions of the 2D layers. Laser scan parameters are assigned to achieve the target melt pool characteristic according to an algorithm derived from preexisting melt pool data for a specified build material. A laser and laser beam steering are controlled according to the assigned laser scan parameters to additively manufacture a part.

Another illustrative embodiment provides a computer-implemented method of certifying digital instructions for powder bed fusion additive manufacturing of a specified alloy. The method comprises recording one or more digital or analog signals controlling an additive manufacturing system energy delivery and position and creating a digital file of a powder bed fusion component according to the digital or analog signals controlling the additive manufacturing system. Laser powers, position, time, and calculated velocity in the digital file are compared to a melt pool database or number of specified rules for the alloy. Each comparison of the laser powers, position, time, and calculated velocity in the digital file to the specified rules is either certified, rejected, or assigned a probability of flaw.

Another illustrative embodiment provides a method of generating a melt pool database for powder bed fusion. The method comprises performing a number of melts on a metal alloy plate wherein the plate has an isotropic (“optically uniform”) surface (defined as absorptivity of the surface that absorbs wavelength of the laser beam with less than 1% variation in absorptivity during the scan) and the plate is scanned with a laser beam, wherein the number of melts is sufficient to determine: a minimum time between adjacent melts before melt pool cross section area deviates by more than 5 percent, a maximum laser power reduction rate that results in end of vector depression less than 20 micrometers, a maximum shift in laser beam spot size before melt pool area deviates by more than 5 percent, and a maximum laser scan speed before melt tracks become discontinuous. The metal plate is sectioned to interrogate melt pool cross section, and the top surface of the metal plate is imaged at 20× magnification or greater after melting.

Another illustrative embodiment provides a method to quantify the quality of a laser beam coupled to a laser beam steering apparatus. The method comprises performing a laser melt pattern, preferably on a metal alloy plate, using the laser beam steering system to include: a number of scans wherein energy is pulsed at a known frequency for a known duration and as the scanner is commanded to move at a constant velocity; and single point exposures of less than 100 μs at a power of less than 200 W with each of the exposures at a different focal length. The top surface of the metal plate is imaged at 50× magnification or greater after melting.

Another illustrative embodiment provides a computer-implemented method of laser powder bed fusion additive manufacturing of parts. The method comprises converting a 3D geometry for a part into a number of 2D layers, wherein the 2D layers contain information about the local 3D geometry. A number of laser scan parameters are specified according to preexisting empirical melt pool data for a specified build material. Laser energy levels are specified according to unique characteristics of a specific powder bed fusion machine. A laser and laser beam steering system in the specific powder bed fusion machine are controlled according to the specified laser scan parameters and specified laser energy levels to additively manufacture the part from the specified build material.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a visual representation of a cross-section of a LPBF melt pool, highlighting common characteristics at the beginning (start), middle, and end of scan vectors;

FIG. 2 depicts a diagram of vector turnaround melt pools and one potential impact of skywriting time;

FIG. 3 depicts a diagram of a LPBF subsystem schematic;

FIG. 4 depicts an example of a focal plane-to-beam waist test via melts on a plate;

FIG. 5 depicts laser beam modulation method to determine scanner speed;

FIG. 6 depicts an aspect of a diagnostic layer scan highlighting different scanner and digital file preparation defects;

FIG. 7 illustrates processing parameters that affect melt pool characteristics and can be evaluated using the plate scan method with diagnostic layer scans, informing the overall parameter development process before powder is ever purchased;

FIG. 8 depicts a P/V map for Ti64 and representative melt pool images from plate scans;

FIG. 9 depicts a P/V map for Al10SiMg, IN718, and Ti64;

FIG. 10 illustrates the effect of laser beam spot size on melt pool depth in C103;

FIG. 11 depicts a multi melt analysis to identify the minimum intervector time for repeatable melts;

FIG. 12 illustrates a melt pool analysis using plate melts and with diagnostic layer scans at multiple locations on the build plate, providing information (in the selected region) on the effect of incident angle on melt pool depth;

FIG. 13 depicts the effect of laser power ramping on back spatter using high speed imaging with image sequence on top using 50 μs power ramping (from 0 to 280 W) and bottom image sequence using 300 μs power ramping (from 0 to 280 W);

FIG. 14 illustrates resulting melt pool tails from laser ramp tests, spatter confirmed by high speed video;

FIG. 15 depicts a scatter plot of constant P/V on IN718 versus Ramp Rate to demonstrate the removal of initial spatter and tails using power ramping;

FIG. 16 illustrates an optical microscope image of plate melt at high incident angle showing that a tail only forms when the laser scans away from the laser center point;

FIG. 17 depicts hypothesized melt pool dynamics affecting spatter and tail formation based on experimental observations;

FIG. 18 the process of selecting the CAD model of the prescribed geometry, slicing into individual layers, determining layer-specific and geometry-specific features, and applying the meltpool database for the layer- and geometry-specific features using defined rules for determining scan vectors, developing print instructions based on the layer- and geometry-specific scan vectors, and finally printing the object layer by layer;

FIG. 19 depicts power adjustment based on local geometry using the layer- and geometry-specific rules combined with the melt pool database;

FIG. 20 is a flowchart illustrating an overall process for creating a melt pool database, creating a rule-based scan path, and verifying application of the rules;

FIG. 21 is a flowchart illustrating a process for rule-based powder ped fusion;

FIG. 22 is a flowchart illustrating a process for certifying digital instructions;

FIG. 23 is a flowchart illustrating a process for creating a melt pool database;

FIG. 24 depicts a diagram illustrating tests for qualifying a powder bed fusion device according to a melt pool database and rule-based scan strategy;

FIG. 25 is an illustration of a block diagram of a data processing system in accordance with an illustrative embodiment;

FIG. 26 depicts a diagram of a melt pool data in accordance with an illustrative embodiment;

FIG. 27 depicts a diagram illustrating generation of rules based on measure melt pools under different scan settings; and

FIG. 28 depicts a table listing different quality control and calibration aspects related to laser and scanner functions described as key process variables.

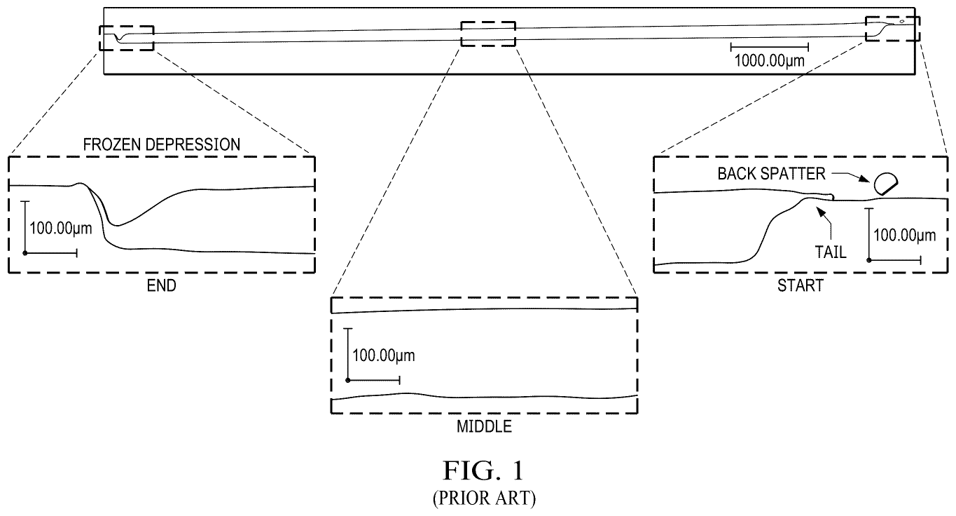

### DETAILED DESCRIPTION

The illustrative embodiments recognize and take into account one or more different considerations as described herein. For example, the illustrative embodiments recognize and take into account that the current approach to scanning strategy is limited to a handful of zones where different geometric features such as downskins, thin walls, part borders and bulk areas are exposed with different powers, speeds, offsets and overlaps. The user control is typically limited to commands that apply when the laser is on, while the parameters that dictate how and when the laser turns on/off and jumps from one vector to the next such as skywriting time and laser delays are commonly hidden. Although hidden, these parameters can have significant impact on the build quality, significantly affecting porosity and surface integrity.

The illustrative embodiments provide a melt pool database comprising experimental data that captures how material behaves to the forming energy sources at relevant process conditions to define limits of acceptable conditions. The illustrative embodiments also provide a method to define the processing conditions directly from the rules defined by data to prevent poor quality material. The illustrative embodiments also provide a method to verify after the fact that the rules were not violated to ensure material quality.

The data can also be used to generate an algorithm that sets laser power, scan speed, hatch spacing, and laser spot size according the melt pool data base that accounts for material, spot size, scan speed, laser power, hatch spacing, laser wave length, boundary conditions, laser travel direction, gas flow direction, incident angle, feedstock size, feedstock shape, feedstock bulk density, layer thickness, 3D and 2D geometry, time, oxygen, feedstock chemistry, scanning system limitations such as jerk and acceleration.

A melt pool is the result of a laser beam heating a material above the melting point of the material. A melt pool can refer to the volume or area of the region that is liquid presently or the region that was liquid but is now solid after solidification. A melt pool can be defined by many different characteristics including size/dimensional qualities such as depth, width, area, perimeter, length, height, or material quality such as grain size, grain orientation, micro hardness, and more. Hatch spacing is defined as the distance between two parallel laser scan paths. Hatch spacing can also define the distance between two laser positions represented as points, pulses, or discontinuous lines. Laser spot size can be defined as the fullwidth half max diameter, four times the standard deviation of the energy distribution, 86% of the energy distribution diameter, or any other diameter definition so long as the definition is constant for parameter assignment. Feedstock defines the material being melted by the laser beam.

The algorithm can be derived from pre existing data to define unallowable laser power, spot size, scan speed, hatch spacing, laser wave length, boundary conditions, laser travel direction, gas flow direction, incident angle, feedstock size, feedstock shape, feedstock bulk density, layer thickness, oxygen, feedstock chemistry, and more.

The algorithm could be defined as a mathematical equation as simple as, e.g., y=mx+b, or as a logical argument such as, e.g., if travel direction is x, increase laser power by y.

A typical LPBF part is composed of millions of single melts or vectors and every vector or melt pool has three distinct phases: the start, the middle, and the end. It is possible to eliminate both back spatter and frozen depressions by simultaneously controlling the laser power and scan speed. If the laser power and scan speed are set below known keyholing parameters, it is unlikely for a stochastic keyhole to form. Similarly, lack of fusion defects are unlikely to form if the hatch spacing to melt depth does not exceed 1, and laser energy is not scattered/absorbed prior to reaching the build plate. When hatch spacing results in a melt pool overlap depth less than the layer thickness defects can occur. The laser material interaction of pulsed or modulated or continuous laser power requires similar control over ramp up and ramp down rates. A lengthwise cross section of a melt pool in IN718 is shown in Error! Reference source not found. and indicates the back spatter and frozen depression typically visible from the cross section of a melt pool.

Both surface integrity and near surface porosity have been identified as critical performance issues requiring improvements to eliminate gaps in LPBF. As-built LPBF surfaces have fatigue performance less than half of fully machined samples. In some cases, near surface pores become surface pores during machining. The surface of a part has the most laser on/off interaction and typically the highest concentration of defects or life limiting flaws. Part location on the build plate is also known to affect surface quality.

Commercial LPBF machines typically take a vector file (in CLI, SLI, MTT, or SLM format) that contains vector start/end positions. The laser and galvanometer (or galvo) are controlled, typically, at 100 kHz.

The entire LPBF community is providing significant investment in attempting to make a repeatable and reproducible process through “band-aids” without addressing the core problems of the process itself.

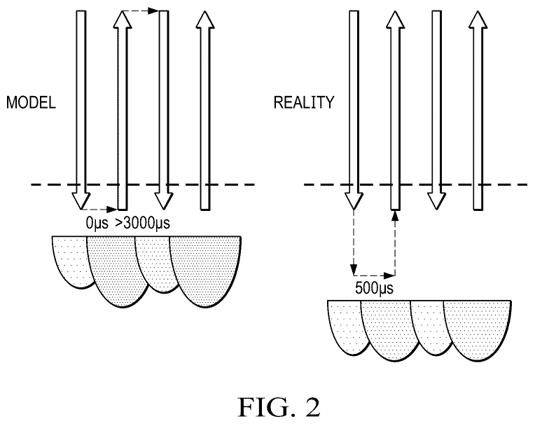

The missing link is the AM toolpath control and, more importantly, toolpath transparency. The industry accepts that the process control happens at the microsecond level but is content to represent the process parameters with a simple spreadsheet. In a recent article focused on the melt pool level simulation, the authors identify the melt pool depth will increase after the hatch turnaround and near overhanging regions due to heat accumulation or lack of time for heat dissipation. Unfortunately, this leaves the author, reader, and industry with no ability to apply this knowledge due to a simple statement made in the text, “Although skywriting was enabled, the ramp-up and ramp-down time is not known, and hence a constant power is assumed throughout the simulation.” FIG. 2 depicts a diagram of vector turnaround melt pools and the impact of skywriting time. Obviously, skywriting time impacts the power (energy/time) input into a region, which ultimately impacts part performance (thermal history of the region). Skywriting time is inherently hidden from the user, and thus, thermal history or part performance for each part is hidden from the user. This lack of transparency considerably impacts the ability of the process to produce components with predictable performance.

The lack of machine “state” documentation (gas flow, spot size, oxygen content) and toolpath transparency render the vast majority of information in the public domain useless. Without transparency in the actual processing conditions (providing spatially and temporally resolved laser beam power and on/off condition for each layer, along with environment chamber conditions such as O₂ concentration, humidity, actual build plate position, and laser optic cleanliness), additional investment in attempting to scale LPBF into a real manufacturing process will be difficult and limited to machine-specific and part-specific qualification scenarios.

All laser powder bed fusion systems are composed of six main sub systems as shown in Error! Reference source not found. Each subsystem plays an important role in the overall part quality.

The laser source and beam steering system qualification are combined since many aspects of these subsystems are difficult to effectively isolate while in the LPBF commercial configuration.

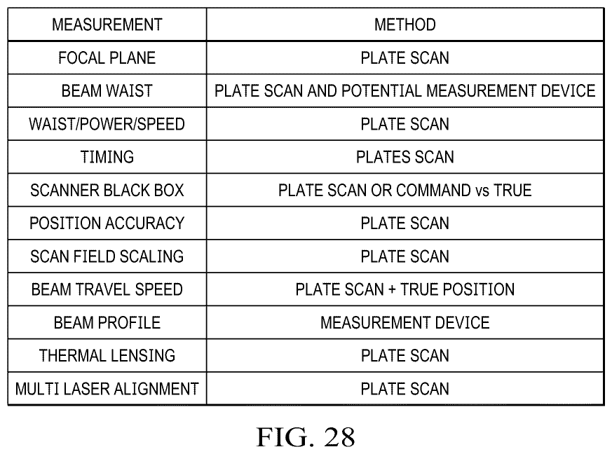

Plate melting can be used to validate focal plane location, incident angle effect, laser power, scan speed and spot size concurrently. The table shown in FIG. 28 lists the various quality control aspects related to laser and scanner functions described as key process variables.

The challenge in performing accurate and repeatable plate melting tests is not trivial. The material, surface finish, scan setting, atmosphere, gas flow, plate position all impact the results.

Based on availability, cost, and quality, it is recommended to use 304SS with brushed finish #4 as it comes with an adhesive film to protect the surface until use. These plates are available through McMaster-Carr for $1.50 per 1″×1″×0.125″ plate and are supplied with certificate of traceability. This is an exemplar method for cost effectively using plate scans as a means for machine qualification. Other methods have been used that incorporate a surface preparation procedure involving sand blasting. Any effective method can be used for this purpose.

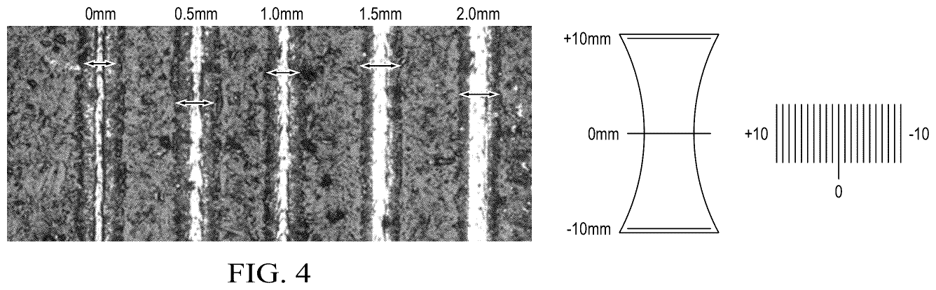

An example test to identify the focal plane relative to build plane on an AconityMINI (Aconity3D, Germany)—a type of commercial LPBF machine, is shown in FIG. 4, which depicts a focal plane-to-beam waist test via melts on a plate. The left most melt is at the working plane of the LPBF machine, and the build platform was subsequently moved 0.5 mm up for each subsequent melt. In this example, the build plane was positioned at the focal waist of the beam.

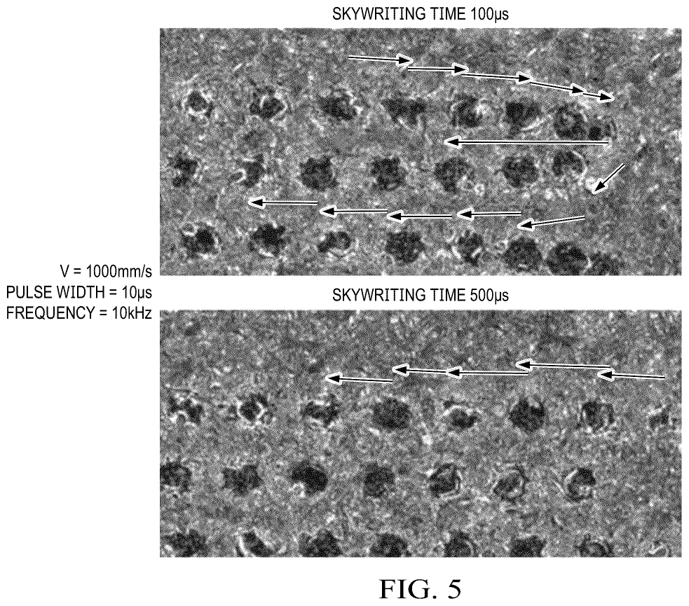

Scan speed can be evaluated by performing a series of pulses utilizing the pulse width modulation function (note: not all systems enable this function, but the lasers are typically capable). To accomplish this, it is recommended to set the pulse width to the system clock rate (typically 10 μs), the modulation frequency to 10 kHz, and the scan speed to 1,000 m/s at a laser power of 75 w if spot size is roughly 80 μm d4σ. These settings will result in center-to-center pulse distance of 100 μm. Performing a series of five 10 mm long vectors in three locations of the print bed should be sufficient to determine the scan speed to less than 50 mm/s. The plate can then be analyzed, and average pulse width distance measured. FIG. 5 shows the results of laser pulse experiments conducted under the previously described settings, highlighting the utility in identifying the galvanometer (scanning mirror system) deceleration due to skywriting time that is too short. If there is no deceleration, the distances between pulses should not change at the beginning or end of vectors.

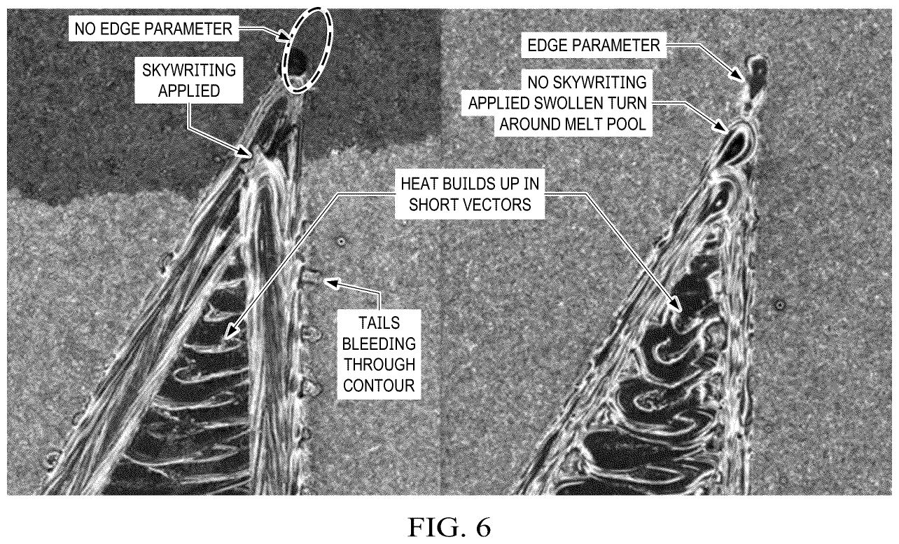

In addition to scan speed and skywriting timing, it is important to evaluate when skywriting is applied, and that the laser on/off timing is synchronized with the position. FIG. 6 enables a direct comparison of an EOS M290 commercial LPBF machine (right) to an AconityMIDI+ commercial LPBF machine (left) for Ti64 plates. A major difference between the two is the lack of skywriting implementation during sharp contours for EOS (right) and the reduced short vector heat buildup in the MIDI+(left), which limits the melt pool size increase as compared with the EOS. These differences are due to the skywriting time difference of 1 ms for AconityMIDI+ and 0.5 ms for EOS. This example, which contains less than 20 vectors for each sample combined with detailed analysis provides more insight into the LPBF machine/process quality than the typical cube that is fabricated throughout the industry for quality checks. With a goal of machine-to-machine repeatability this simple example raises the simple question; how can we attempt part equivalency if such a small test cannot produce identical results?

The chamber as designed serves multiple functions, but the primary purpose is environmental control. Most metals used in LPBF are sensitive to oxidation at high temperatures and control of the residual oxygen in the chamber is required. The effect of chamber oxygen of 200 ppm vs 1000 ppm was shown to result in a 150 ppm difference in the final oxygen content of Ti64 parts. The EOS M 290 utilizes a Figaro GS Oxygen sensor KE-25, which reports an error of ±1% full scale (full scale of approximately 230,000 ppm since the sensor is calibrated with atmosphere) meaning the measurement error would be ±2300 ppm making control to 1000 ppm essentially impossible; however, the inventors could not identify any documentation from the OEM on accuracy of the oxygen measurement. SLM Solutions and Renishaw systems utilize the BOSCH LSH25 sensor, which can be sourced from an auto parts store, and does not have a reported standard error for the application of controlling oxygen below 1000 ppm in the public domain. Sensors designed for full scale uses (atmosphere to 1 ppm) are unlikely to provide the accuracy and repeatability at both extremes, and therefore, it is recommended the industry adopt a two-sensor approach that enables chamber control down to <10 ppm±5 ppm. Furthermore, NIST traceable calibration gas at approximately 100 ppm oxygen should be utilized to certify sensors during preventative maintenance. By adopting this change, it is anticipated that powder degradation over time will decrease dramatically as shown by 3Dsystems as they control oxygen to <10 ppm and the repeatability of all material properties collected will increase since oxygen can lead to changes in strength, hardness, ductility, facture toughness, and detrimental inclusions.

The temperature in the scanner and the collimator are to be monitored in addition to the chamber temperature near the optics and be maintained within ±1° C. for the entirety of builds and that the setpoint for the chiller be established for the entire facility for all qualified machines.

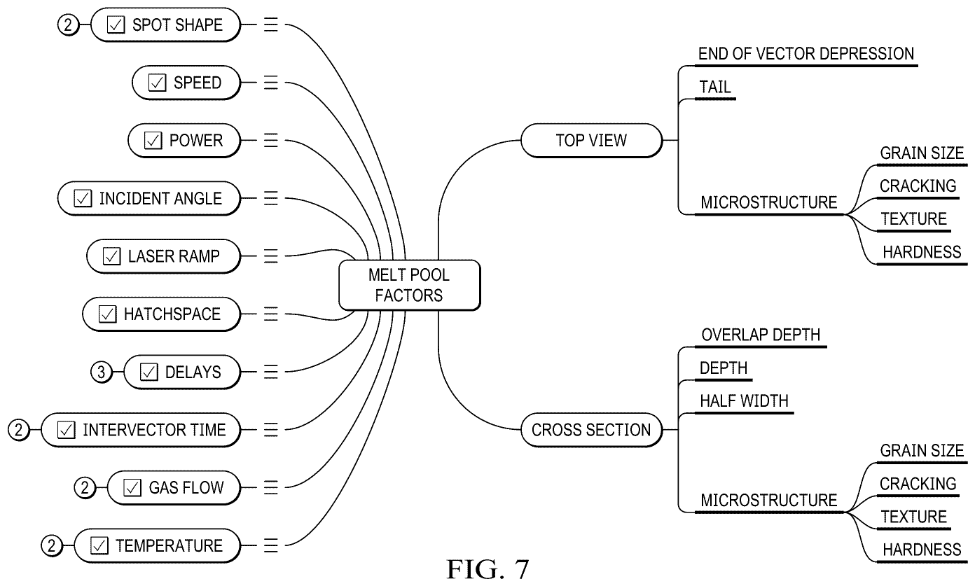

FIG. 7 illustrates processing parameters that affect melt pool characteristics and can be evaluated using the plate scan method with diagnostic layer scans, informing the overall parameter development process before powder is ever purchased.

Process parameter development shall be performed for laser powder bed fusion not for a machine make/model. Although some machines may utilize different laser spot size or laser powers, the goal of parameter development is to develop process parameters for a material melted by a laser. The method works for the machine first (i.e., location within a specific machine this is a function of laser incident angle, gas flow, and other variables). Preferably, the machine is qualified first (i.e., meets minimum metrics), and then a more general (material/laser) approach is used.

Error! Reference source not found. defines the number of parameters that affect the LPBF process that can be interrogated with bead on plate testing and the type of analysis to be done to maximize the value of each melt pool.

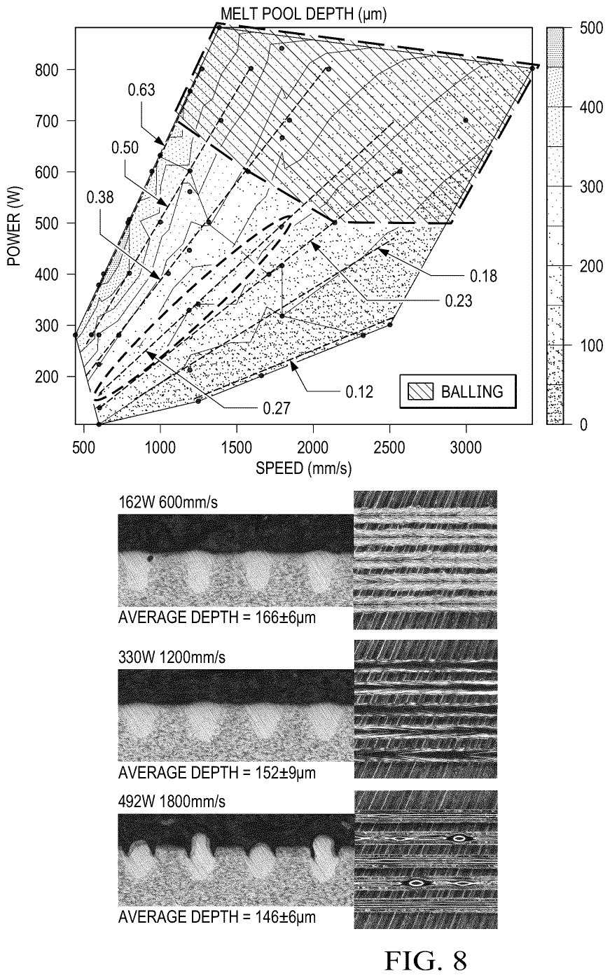

Material qualification begins with power velocity mapping, an example of which is shown in FIG. 8 as it will provide a general direction for all future testing. A series of melts are to be performed at multiple powers and speeds to find the desired melt pool characteristics and what creates undesired melt pools. Desired melt pools have a melt pool aspect ratio of 0.5 to 1.5 depth to width and produce a continuous and uniform appearance. Undesirable characteristics including balling, keyhole mode melting, and microstructure deviations resulting in measurable difference in material properties regardless of melt pool size. Balling is defined as a discontinuous melt pool where the top surface of the melt produces greater than 10% width or height. Keyhole melting is defined by melt pool depth 1.5 times greater than melt pool width. Variation in microstructure or properties can be defined as grain size, grain shape, precipitate size or distribution, or hardness variability exceeding 5% or 10%. In addition to defining the power and speed and laser spot size combinations that result in melt pool depth to width ratios of 0.5 to 1.5 the parameters should define powers, speeds, and spot sizes that result in melt pool depths of less than 50 micrometers.

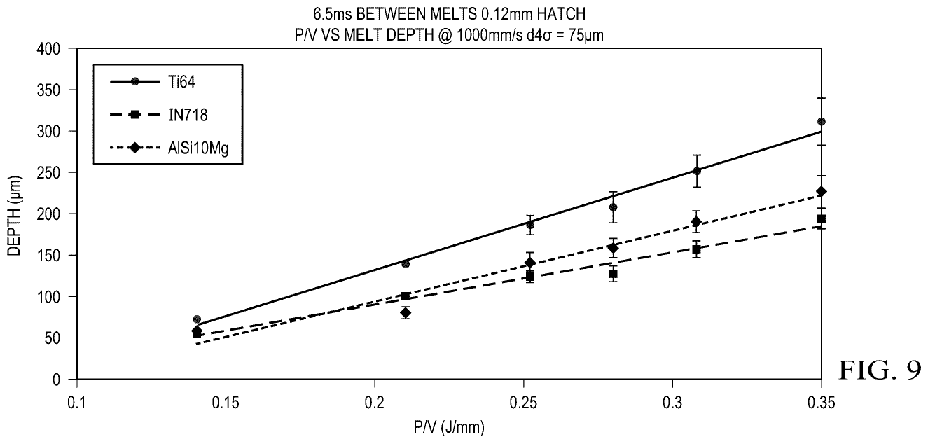

The P/V map for common alloys in LPBF is presented in FIG. 9 for a laser spot size of d4σ=75 μm. In general, near the transition melt mode, the P/V diagram is linear when beam size is held constant and has been shown to similarly was for Cu, Mo, and Nb alloys in unpublished work by the inventors and by others.

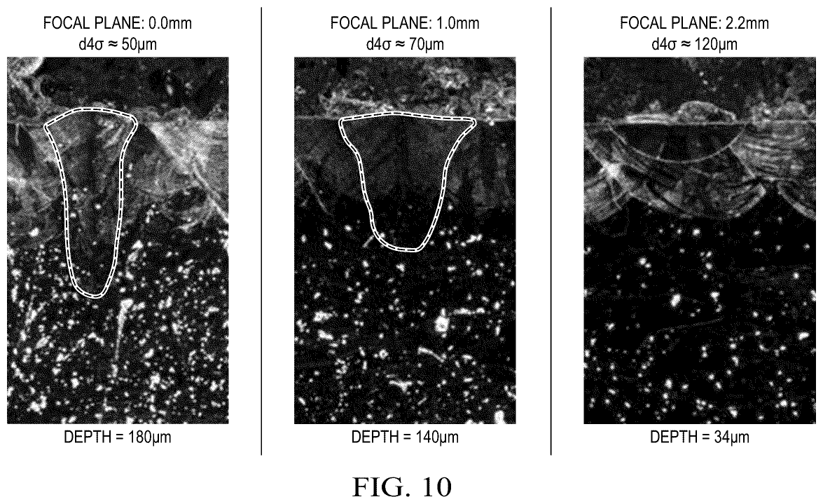

Beyond P/V maps for a single spot size, the effect of spot size on microstructure and melt pool must be evaluated. Spot sizes vary between systems and the laser beam diameter influences productivity, resolution, spatter, and microstructure. Larger beam diameters enable greater build rates but also increase the melt pool size which can alter the resulting microstructure formed by smaller beams. The effect of spot size is known to affect microstructure and these microstructure variants can remain after heat treatment alloys like IN718[46]. Each alloy has potentially different sensitivity to spot size, but this can be identified and used to establish machine classification. For example, Alloy X may need one set of design allowables for a machine with beam size 70-140 μm and one with beam sizes 140-500 μm. The initial screening can be achieved utilizing the plate melt approach. The effect of laser spot size on melt pool formation at constant laser power and scan speed at various beam d4σ diameters on C103 plate shown in FIG. 10.

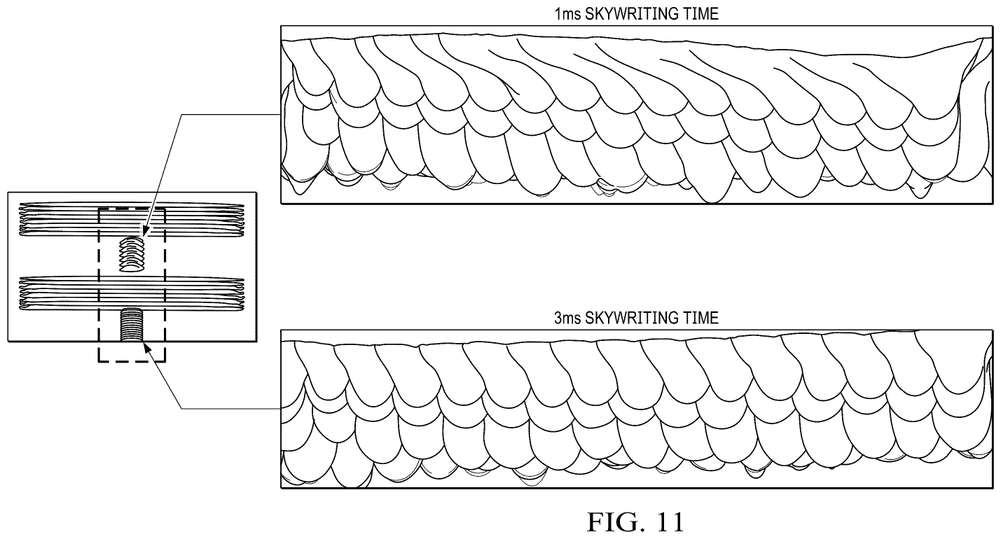

With knowledge of scan speed, spot size, and laser power sensitivity, the effort can transition to hatching melts. The material qualification should identify other practical bounds, such as minimum intervector time, effect of laser incident angle, and the effect of pre heat (heated build plate) to maintain similar melt pool shape, defined as melt pool area, melt pool aspect ratio, or melt pool perimeter that does not change by more than 10% from melt pools performed under identical power and speed at room temperature with near vertical incident angle and inter vector time of at least 8 milliseconds. The minimum intervector time can be determined by performing successively shorter vectors or by performing short vectors with successively longer intervector times. An example of 1 mm vector in IN718 with 1 ms intervector time vs 3 ms intervector time is shown in FIG. 11 and clearly shows that 1 ms results in drastic melt pool shape change whereas 3 ms enables uniform melt pools.

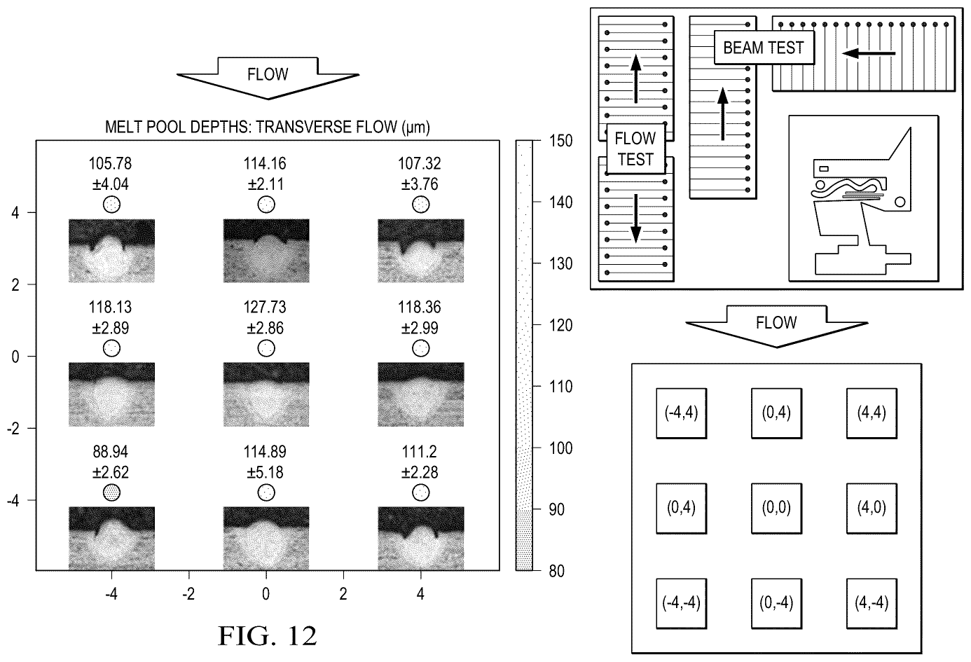

Plate scans can also drive the industry toward uniformity in melt pools across build platforms by quantifying the effect of laser incident angle and scanning direction on melt pool morphology. The effect of incident angle can be defined by performing single vector melts with long (>1 see) delays between vectors. FIG. 12 represent 135 single vector melts performed on Ti64 in an EOS M290 that were sectioned and measured for melt pool depth. This test was able to quantify the reduction in melt pool penetration at the extreme incident angles with up to a 30% reduction in penetration for the worst location as compared to the center of the platform. This effect could be removed by location-specific laser power or speed, for example, selected to produce the same melt pool depth across the platform. Evaluations based on laser incident angle enable lessons learned from single laser systems to be applicable to multi laser systems as well.

Upon the completion of the melt pool analysis for an alloy that fully defines the effects identified in Error! Reference source not found., the next step would be to define a set of rules in order to not violate known regions of the process space that result in melt pool shapes exceeding the target (typically a melt pool depth 1 to 1.2 times the melt width but not to exceed 1.5). With this knowledge, a scan strategy must be deployed that does not violate the rules which can be confirmed empirically, through part production and examination or digitally by evaluated the scanner position and laser power at the controlled rate.

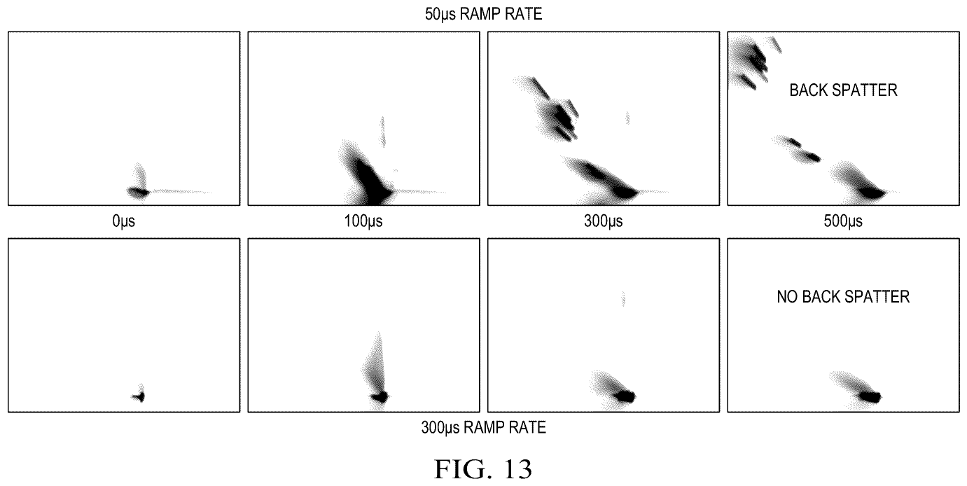

FIG. 13 depicts the effect of laser power ramping on back spatter using high speed imaging with image sequence on top using 50 μs power ramping (from 0 to 280 W) and bottom image sequence using 300 μs power ramping (from 0 to 280 W).

Laser ramp rates from 5 μs to 400 μs were conducted and back spatter observed at 5 μs, 50 μs, and 100 μs in every vector melted for IN718. At 200 μs, back spatter was still observed in several vectors but not every vector. At a ramp of 300 μs and 400 μs, no back spatter was observed.

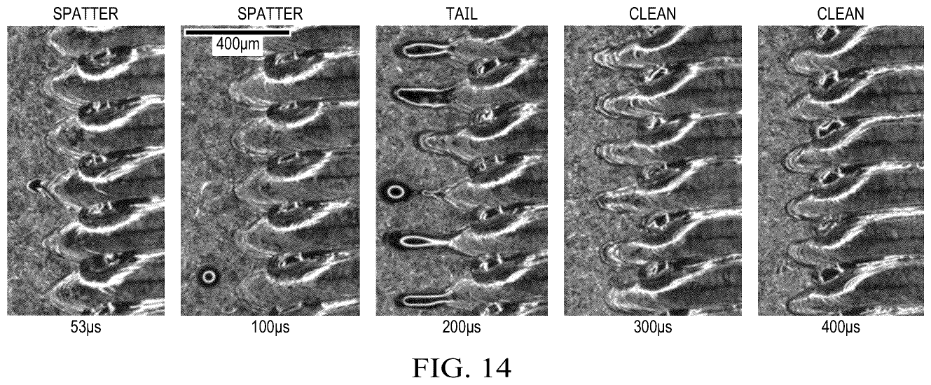

Post melt investigation of the plates indicated a distinct transition from back spatter>tail>clean melt. In IN718, a transition zone was identified at 200 μs as seen in FIG. 14 where a tail forms and freezes in place at the start of a vector.

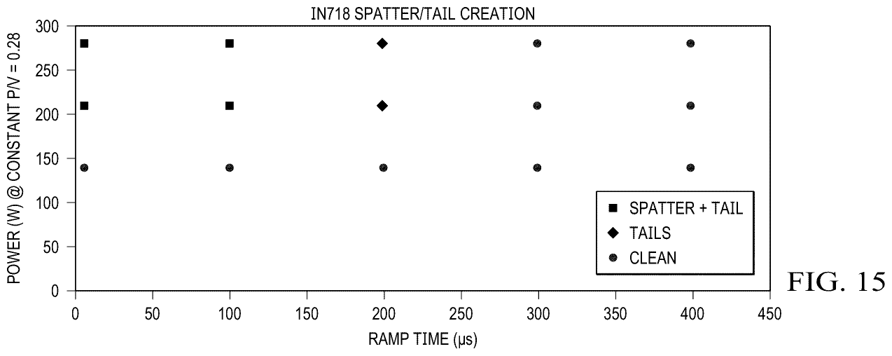

The factors studied and described below are contained in Table 2. To investigate the effect of scan speed, melts were performed at 75% and 50% nominal velocity (1000 mm/s for IN718) while maintaining an equivalent power:velocity ratio (0.280 for IN718). The results of all melts performed on IN718 at 0° incident angle are shown in FIG. 15. No back spatter or tails were observed at 50% velocity, 50% power conditions, indicating that lower processing speeds may have benefits with regard to spatter creation although lower processing speeds will negatively impact productivity.

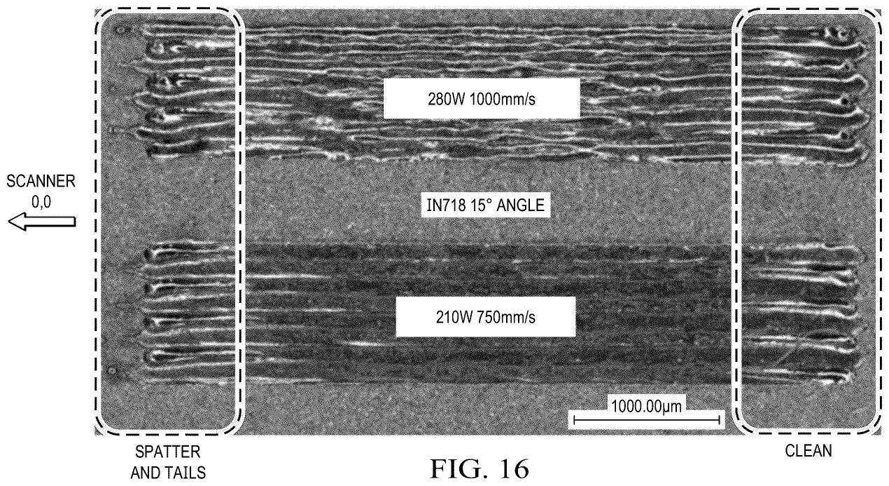

To inspect the effect of laser incident angle, plate melts were performed at different distances from the scanner center. FIG. 16 shows melts on IN718 without ramp at ˜15° incident angle, and spatter and tails were only observed when the laser travels away from the scanner while no tail or spatter is observed when the laser travels back towards the scanner. This observation challenges the use of recoil pressure induced by thermal gradients as a basis for ejection and indicates that the direction of recoil pressure relative to travel direction affects the melt pool shape. This experiment found that laser incident angle creates a complicated melt pool/spatter interaction, and, perhaps most importantly, that the direction of the scanning vector impacts this interaction.

All data used to control the laser beam to create melt pools along with the melt pool analysis to include images or the melt pools from the top view or from cross sections will be linked and stored in a database. The linking of input parameters such as scan speed, laser power, focus, and position to melt pool measurement will have a resolution of less than 1 mm or less than 0.1 mm. An example of this would be a melt pool image is saved along with a measurement such as melt pool depth and this image is link to the process conditions during its formation to enable linkage of the input parameters to the resulting melt pool depth.

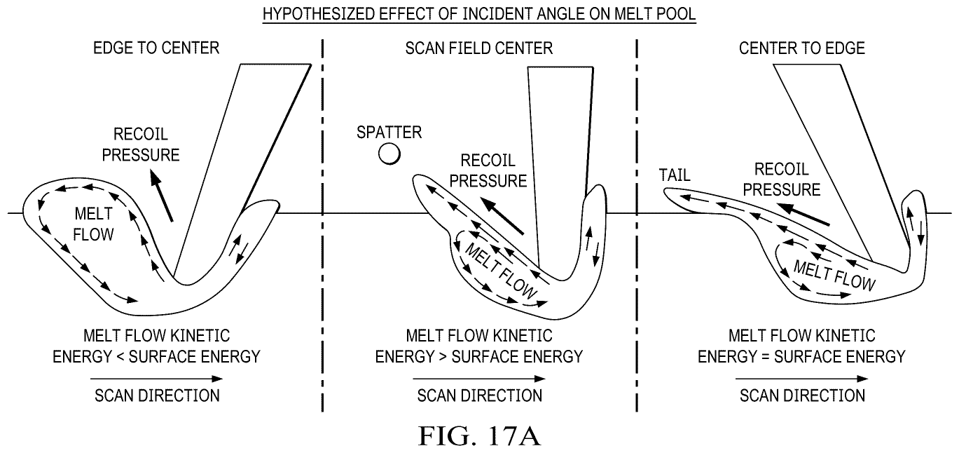

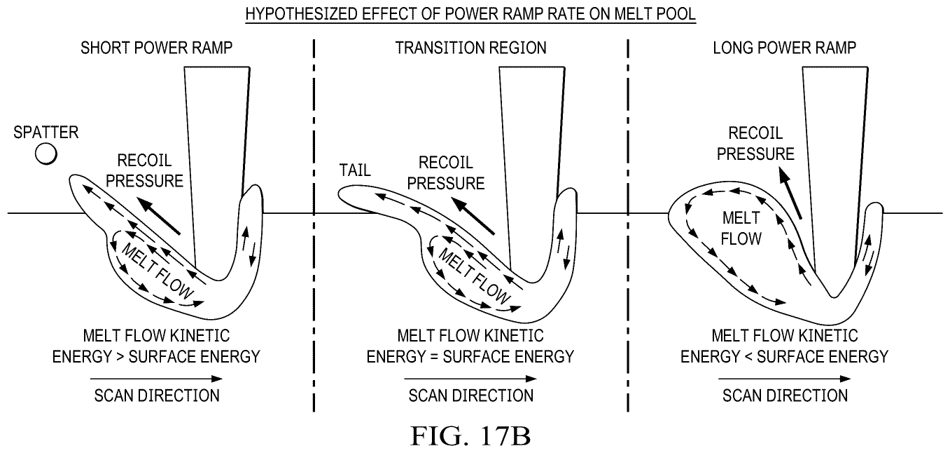

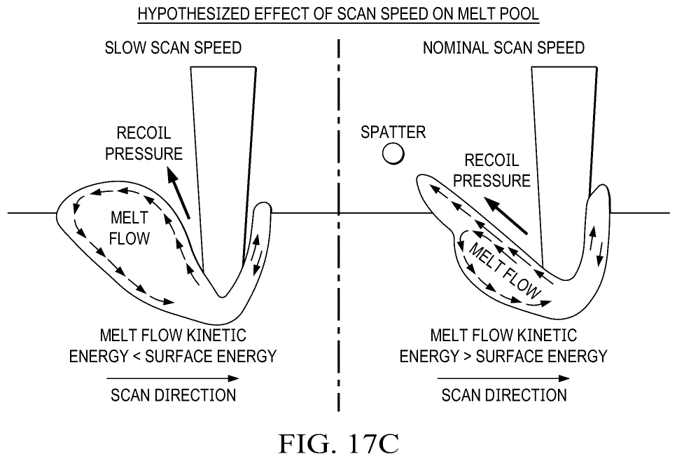

FIG. 17 illustrates the potential effect of scan speed, incident angle, scan direction, and ramp rate on direction of the induced recoil pressure and melt size.

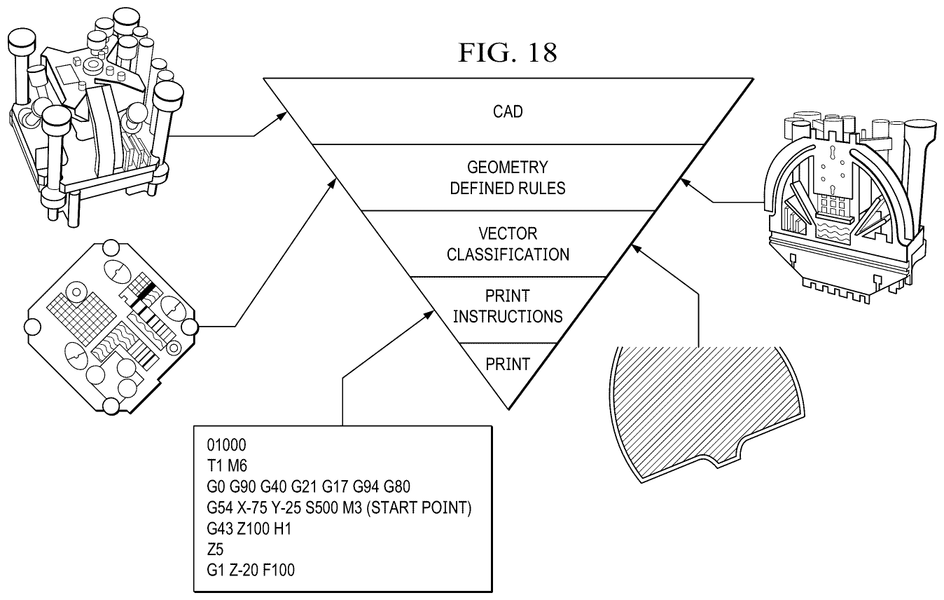

The combination of all information captured above can be pooled into a database to create rules for scan strategy. FIG. 18 shows how a 3D geometry can be classified based on zones (geometric zones such as thin walls vs thick walls or print location zones defined by laser beam incident angle). The 3D zones are converted into 2D layers that maintain the 3D information in pixel or other formatting. The information may include local depth. Vectors or melt commands can be overlaid or applied which utilizes the pixel information to define scan speed, laser power, or beam focus. The information is then converted into machine readable instructions where knowledge of the machine is required to adjust for incident angle, gas flow, multi laser aspects of the process.

Skywriting is a method developed to account for differences in response to changes between laser and scanner (energy steering). Essentially it accounts for momentum of the mirrors. The melt pool has analogous “momentum” where the melt pool (depth, width, shape) does not respond to changes in energy at the same rate the energy can be changed. This will be subsequently referred to as melt pool dynamics. The ramp rate to form back spatter is an example of the dynamic effect associated with the laser and material interaction—the melt pool dynamics. The melt pool length and the end of vector depression also indicate melt pool dynamics. A characteristic melt pool dynamics factor or characteristic time scale is to be quantified as part of the melt pool database, including specific rules required for scan strategy implementation. The dynamics of the melt pool is used to adjust when power/speed changes occur by looking forward in an individual vector at a characteristic time.

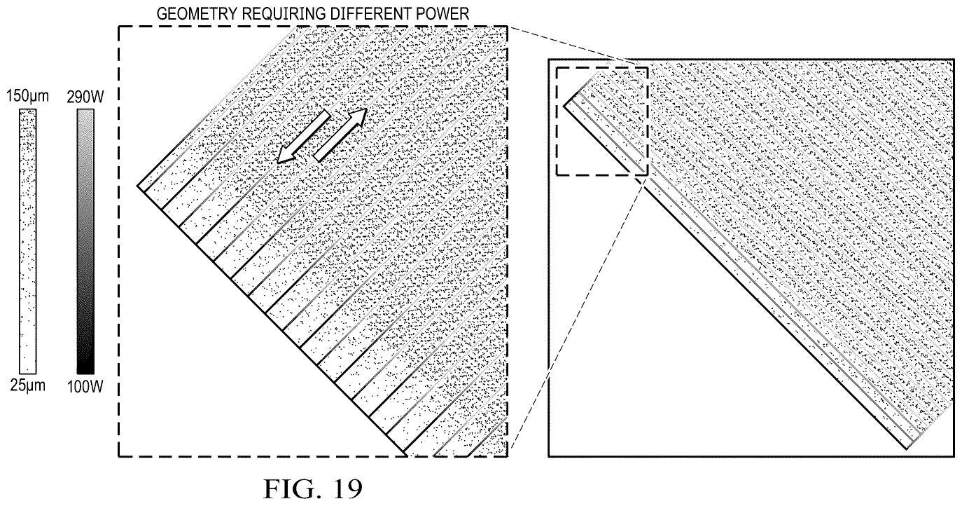

An example of this process is shown in FIG. 19, which illustrates power adjustment based on local geometry. Although the geometry is identical two adjacent vector may have different power to account for time and/or direction. A vector changing from high power (thick area) to lower power (thin or overhanging area) may need to adjust power earlier to account for the meltpool momentum (meltpool response is slower than the change in delivered energy as shown in the plate melt forming back spatter). This momentum parameter can also be used to define ramp down rates to prevent frozen depressions at the end of vectors and spatter at the beginning of vectors.

Although the geometry is identical, two adjacent vectors may have different power to account for time and/or direction. A vector changing from high power (thick area) to lower power (thin or overhanging area) may need to adjust power earlier to account for the melt pool dynamics (melt pool response is slower than the change in delivered energy as shown in the plate melt forming back spatter).

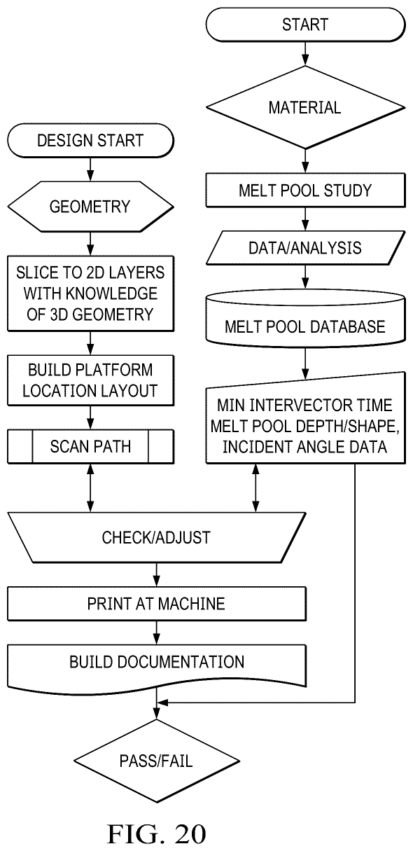

FIG. 20 is a flowchart illustrating an overall process for creating a melt pool database, applying the database to create a rule-based scan path, and verifying that the rules have been followed in a build.

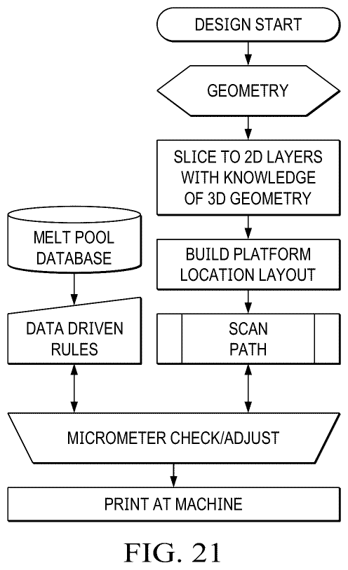

FIG. 21 is a flowchart illustrating a process for rule-based powder ped fusion.

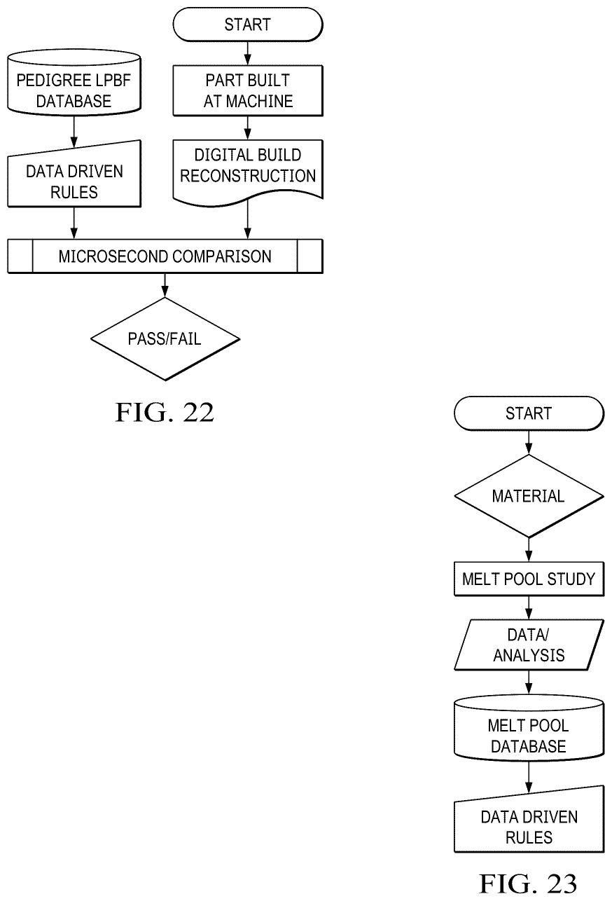

FIG. 22 is a flowchart illustrating a process for certifying digital instructions.

FIG. 23 is a flowchart illustrating a process for creating a generating a melt pool database.

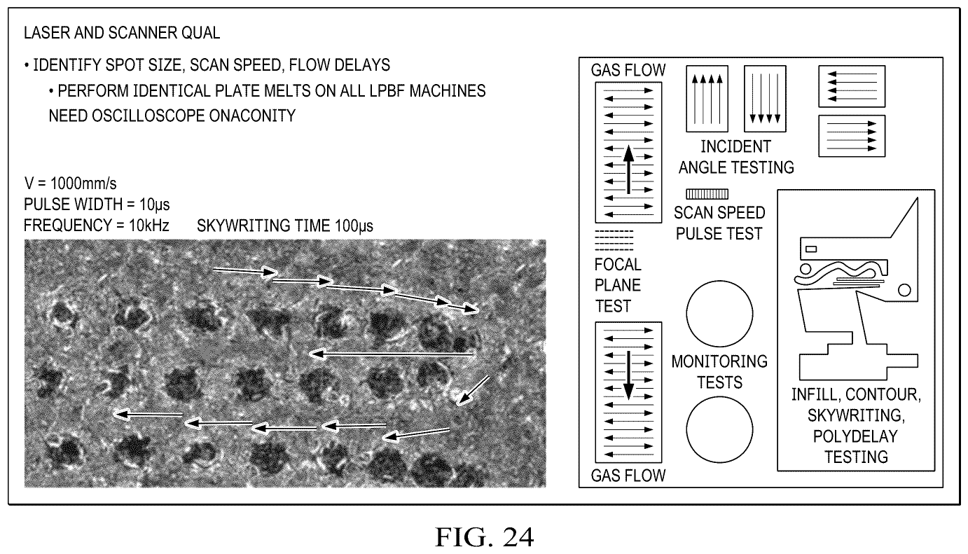

FIG. 24 depicts a diagram illustrating tests for qualifying a powder bed fusion device according to a melt pool database and rule-based scan strategy.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware can, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

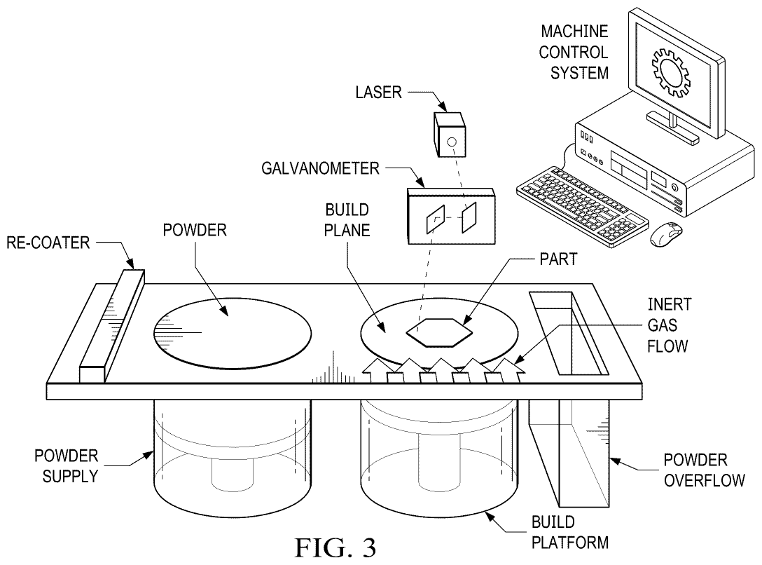

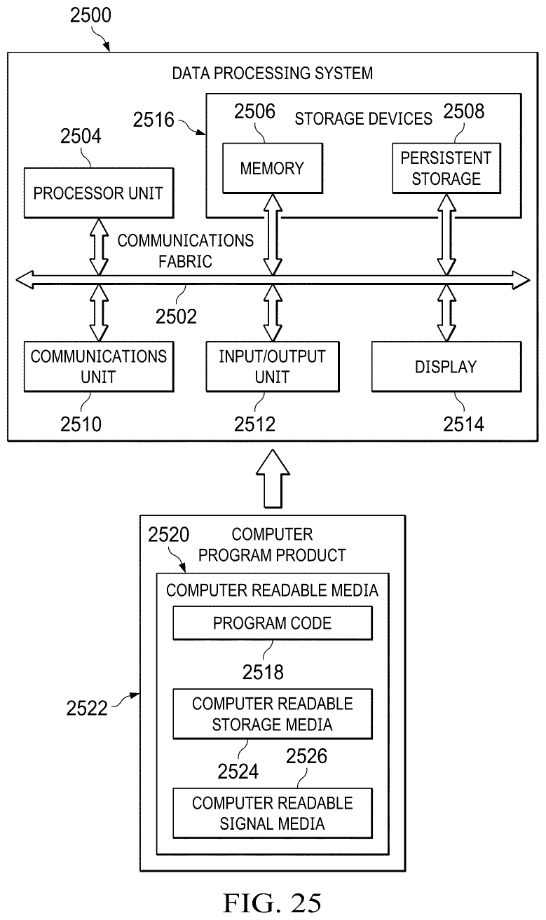

Turning now to FIG. 25, an illustration of a block diagram of a data processing system is depicted in accordance with an illustrative embodiment. Data processing system 2500 may be used to implement the machine control system in FIG. 3. In this illustrative example, data processing system 2500 includes communications framework 2502, which provides communications between processor unit 2504, memory 2506, persistent storage 2508, communications unit 2510, input/output (I/O) unit 2512, and display 2514. In this example, communications framework 2502 takes the form of a bus system.

Processor unit 2504 serves to execute instructions for software that may be loaded into memory 2506. Processor unit 2504 may be a number of processors, a multi-processor core, or some other type of processor, depending on the particular implementation. In an embodiment, processor unit 2504 comprises one or more conventional general-purpose central processing units (CPUs). In an alternate embodiment, processor unit 2504 comprises one or more graphical processing units (GPUs).

Memory 2506 and persistent storage 2508 are examples of storage devices 2516. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 2516 may also be referred to as computer-readable storage devices in these illustrative examples. Memory 2506, in these examples, may be, for example, a random access memory or any other suitable volatile or non-volatile storage device. Persistent storage 2508 may take various forms, depending on the particular implementation.

For example, persistent storage 2508 may contain one or more components or devices. For example, persistent storage 2508 may be a hard drive, a flash memory, a rewritable optical disk, a rewritable magnetic tape, or some combination of the above. The media used by persistent storage 2508 also may be removable. For example, a removable hard drive may be used for persistent storage 2508. Communications unit 2510, in these illustrative examples, provides for communications with other data processing systems or devices. In these illustrative examples, communications unit 2510 is a network interface card.

Input/output unit 2512 allows for input and output of data with other devices that may be connected to data processing system 2500. For example, input/output unit 2512 may provide a connection for user input through at least one of a keyboard, a mouse, or some other suitable input device. Further, input/output unit 2512 may send output to a printer. Display 2514 provides a mechanism to display information to a user.

Instructions for at least one of the operating system, applications, or programs may be located in storage devices 2516, which are in communication with processor unit 2504 through communications framework 2502. The processes of the different embodiments may be performed by processor unit 2504 using computer-implemented instructions, which may be located in a memory, such as memory 2506.

These instructions are referred to as program code, computer-usable program code, or computer-readable program code that may be read and executed by a processor in processor unit 2504. The program code in the different embodiments may be embodied on different physical or computer-readable storage media, such as memory 2506 or persistent storage 2508.

Program code 2518 is located in a functional form on computer-readable media 2520 that is selectively removable and may be loaded onto or transferred to data processing system 2500 for execution by processor unit 2504. Program code 2518 and computer-readable media 2520 form computer program product 2522 in these illustrative examples. In one example, computer-readable media 2520 may be computer-readable storage media 2524 or computer-readable signal media 2526.

In these illustrative examples, computer-readable storage media 2524 is a physical or tangible storage device used to store program code 2518 rather than a medium that propagates or transmits program code 2518. Computer readable storage media 2524, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 2518 may be transferred to data processing system 2500 using computer-readable signal media 2526. Computer-readable signal media 2526 may be, for example, a propagated data signal containing program code 2518. For example, computer-readable signal media 2526 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 2500 are not meant to provide architectural limitations to the manner in which different embodiments may be implemented. The different illustrative embodiments may be implemented in a data processing system including components in addition to or in place of those illustrated for data processing system 2500. Other components shown in FIG. 25 can be varied from the illustrative examples shown. The different embodiments may be implemented using any hardware device or system capable of running program code 2518.

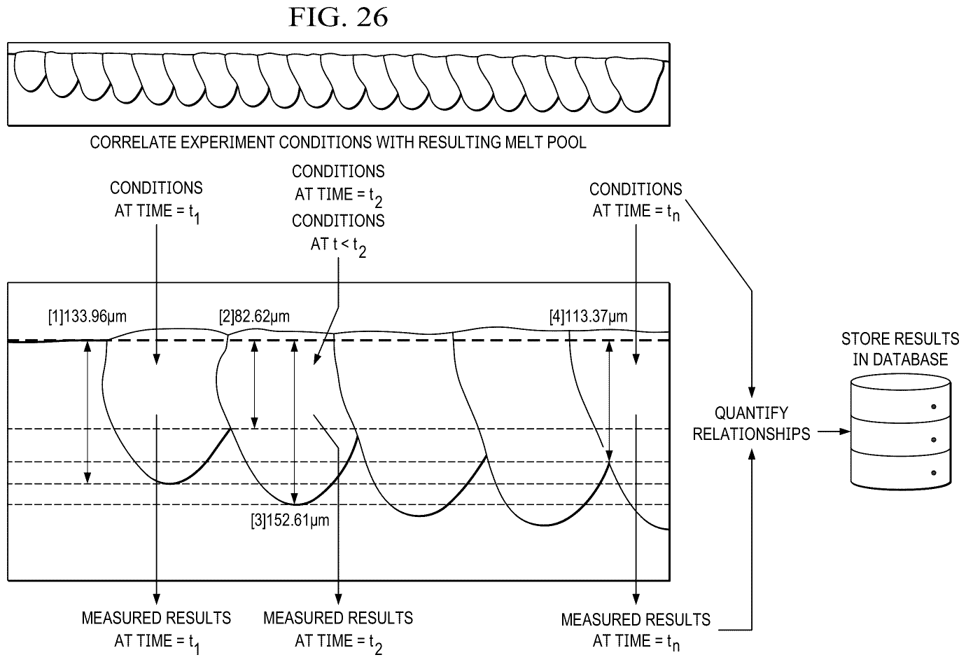

FIG. 26 depicts a diagram of a melt pool data in accordance with an illustrative embodiment. FIG. 26 describes the generation of a melt pool database used to establish formulas/equations/rules for determine scan strategy and scan settings. Controlled experimental laser marks on a plate of known chemistry and surface condition are done with predefined scan conditions. The laser beam power and caustic and profile are experimentally recorded prior to the experiments within 1 week of experimentation. The control of the laser beam and beam steering system are recorded during the experiments. After the experiment, the plates are imaged from the top with a magnification of 100×. The plates are then sectioned. The section samples are measured from the section location to a reference on the plate such as the end of a melt pool or other marking. The plates are then mounted, and the thickness of the mount is measured and recorded. The plates are then ground, polished, etched and re measured to determine what location the section is relative to the scan file to enable correlation of melt pool data to scan data. The face of the sample with melt pools revealed is imaged at 300× magnification. The imaged melt pools are then measured for at least one of the following: depth, overlap dept, width, width at a specified depth, area, shape, perimeter, half width. The sample may then be subjected to microhardness analysis, wear analysis, or other analysis to include elemental analysis, grain structure analysis, crystallographic analysis, texture analysis.

Each melt pool is correlated with the scan setting for that time and location creating a link between process conditions and resulting melt pool data. Each melt pool in a test where multiple melts are done with overlap also contains the information to include time and distance of all previous melt pools in the experimental set. This includes a series of melts that are referred to as hatching scans where melt pools overlap and therefore the adjacent melt pools may cause changes in the melt pool result due to heat transfer. In many cases a number of non-overlapping melts are performed to establish statistics to include average and standard deviation. Similarly hatching or overlapping vectors will typically include at least 10 melt pools to enable the development of statistical data.

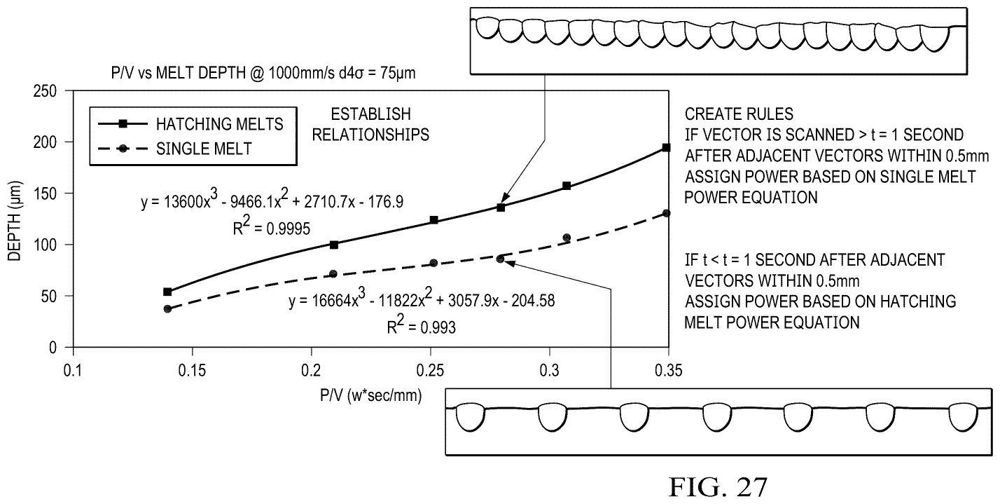

FIG. 27 depicts a diagram illustrating generation of rules based on measuring melt pools under different scan settings. The results of the overlapping melt pool tests and non over lapping melt pool tests can be compared with all other scan setting kept constant to create a relationship for the effect of heat transfer. This relationship can be used to establish rules such as what scan power to be utilized for a given vector in a laser powder bed fusion build. Creating a series of melts at different powers while all other variables are kept constant enables the creation of an equation to estimate melt pool depth for example based on laser power. This can again be done for overlapping and non-overlapping melt pools to create two equations and the laser power for a given point in a vector of a build can be assigned by plugging in the target melt pool depth for that location into the appropriate equation as determined by knowledge of any adjacent overlapping vectors. The combination of multiple rules and or multiple equations can be used to generate an algorithm that includes logical arguments to formalize the selection of rules and equation given input data.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

As used herein, “a number of” when used with reference to items, means one or more items. For example, “a number of different types of networks” is one or more different types of networks. In illustrative example, a “set of” as used with reference items means one or more items. For example, a set of metrics is one or more of the metrics.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method of laser powder bed fusion additive manufacturing of parts, the method comprising:
using a number of processors to perform the steps of:
converting a 3D geometry into 2D layers, wherein the 2D layers contain information about the 3D geometry, and wherein the 2D layers define at least a maximum allowable melt pool depth to regions of the 2D layer;
specifying a number of laser scan parameters according to preexisting melt pool data for a specified build material, wherein the scan parameters include:
minimum times between at least two adjacent overlapping melt pools of the build material;
minimum and maximum allowable laser spot size;
specifying a number of laser energy levels according to laser incident angle; and
controlling a laser and laser beam steering according to the specified laser scan parameters and laser energy levels to additively manufacture a part.

2. The method of claim 1, wherein the 2D layers further define a maximum allowable thermal/energy gradient.

3. The method of claim 1, wherein the regions of the 2D layers may comprise:
points;
pixels; or
areas of 1 square micron to 100 square mm in size.

4. The method of claim 1, wherein the 2D layers further define minimum and maximum melt pool overlap depths.

5. A computer-implemented method of laser powder bed fusion additive manufacturing of parts, the method comprising:
using a number of processors to perform the steps of:
converting a 3D geometry into 2D layers, wherein the 2D layers contain information about the 3D geometry, and wherein the 2D layers define at least one target melt pool characteristic for regions of the 2D layers;
assigning laser scan parameters to achieve the target melt pool characteristic according to an algorithm derived from preexisting melt pool data for a specified build material; and
controlling a laser and laser beam steering according to the assigned laser scan parameters to additively manufacture a part.

6. The method of claim 5, further comprising adjusting laser energy according to laser incident angle.

7. The method of claim 5, wherein the parameters further comprise at least one of:
a maximum acceleration of a number of galvanometer motors in a powder bed fusion device;
a maximum jerk of a number of galvo motors in a powder bed fusion device;
a qualified gas flow velocity distribution;
a number of prohibited vector scan directions;
a number of melt pool momentum adjustments;
a maximum allowable scan speed; or
a laser energy adjustment prior to or after a change in geometry to account for melt pool response time.

8. The method of claim 5, wherein hatch spacing is adjusted to reduce energy gradients within a layer according to geometric differences.

9. The method of claim 5, wherein an energy balance for a 2D region is used to adjust the laser scan parameters.

10. The method of claim 9, wherein the energy balance includes a ratio of laser energy into a 2D layer versus calculated energy conducted out of the region is used to further adjust the laser scan parameters.

11. The method of claim 5, wherein melt pool depth is kept constant between two regions of a 2D layer and melt pool overlap depth is controlled to be different and within allowable overlap depths.

12. A computer-implemented method of certifying digital instructions for powder bed fusion additive manufacturing of a specified alloy, the method comprising:
using a number of processors to perform the steps of:
recording one or more digital or analog signals controlling an additive manufacturing system energy delivery and position;
creating a digital file of a powder bed fusion component according to the digital or analog signals controlling the additive manufacturing system;
comparing laser powers, position, time, and calculated velocity in the digital file to a melt pool database or number of specified rules for the alloy; and
certifying, rejecting, or assigning a probability of flaw to each comparison of the laser powers, position, time, and calculated velocity in the digital file to the specified rules.

13. The method of claim 12, wherein the digital file comprises a time history of energy, position, and build chamber conditions.

14. The method of claim 13, wherein the digital file includes at least one of the following build chamber conditions: oxygen, humidity, build plate location, scanner temperature, build chamber temperature, optics temperature, laser source temperature, volumetric gas flow rate, build chamber pressure, or powder layer thickness.

15. The method of claim 12, wherein the digital file is compared to a look up table.

16. The method of claim 12, wherein the digital file is converted to a digital 3D geometry, and wherein the melt pool data is interpolated to create a digital 3D volume for every captured laser power/velocity/time.

17. A method of generating a melt pool database for powder bed fusion, the method comprising:
performing a number of melts on a metal alloy plate with a laser beam, wherein the number of melts is sufficient to determine:
a minimum time between adjacent melts before melt pool area deviates by more than 5 percent;
a maximum laser power reduction rate that results in end of vector depression less than 20 micrometers;
a maximum shift in laser beam spot size before melt pool area deviates by more than 5 percent;
a maximum laser scan speed before melt pools form discontinuous tracks of greater than 5 percent width variation;
wherein the plate has a surface roughness arithmetic mean greater than 0.5 but less than 4 micrometers;
sectioning the metal plate to interrogate melt pool cross section; and
imaging a top surface of the metal plate at after melting.

18. The method of claim 17, wherein melts are sufficient to quantify at least one of:
a minimum laser power ramp down rate to prevent a frozen depression; or
incident angle effects with at least two locations with one having a laser incident angle at least 5 degrees from vertical.

19. The method of claim 17, wherein the melt pool database comprises a conversion factor for the effect of powder, wherein the effect of powder includes at least one of:
effect of different layer thickness of powder;
powder size;
powder shape;
powder absorptivity of laser energy relative to plate; or
bulk powder density.

20. A method to quantify the quality of a laser beam coupled to a laser beam steering apparatus, the method comprising:
performing a laser melt pattern to include:
a number of scans wherein energy is pulsed at a known frequency for a known duration and as a scanner is commanded to move at a constant velocity;
and
imaging a top surface of a metal alloy plate at 50× magnification or greater after melting.

21. The method of claim 20, further comprising performing melts on the metal alloy plate to form a pattern to ensure the laser is commanded to perform turns of at least 150 degrees, jumps, hatching, and power changes due to different geometry induced scan settings.

22. A computer-implemented method of laser powder bed fusion additive manufacturing of parts, the method comprising:
using a number of processors to perform the steps of:
converting a 3D geometry for a part into a number of 2D layers, wherein the 2D layers contain information about the 3D geometry;
specifying a number of laser scan parameters according to preexisting empirical melt pool data for a specified build material;
specifying laser energy levels according to unique characteristics of a specific powder bed fusion machine; and
controlling a laser and laser beam steering in the specific powder bed fusion machine according to the specified laser scan parameters and specified laser energy levels to additively manufacture the part from the specified build material.
